(19) United States
(12) Patent Application Publication
(10) Pub. No.: US 2005/0285295 A1
(43) Pub. Date: Dec. 29, 2005

(54) Heat embossing method and apparatus

(76) Inventor: Darcee Thompson, Preston, ID (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/871,801

(22) Filed: Jun. 18, 2004

(51) Int. Cl. B29C 67/00

(52) U.S. Cl. 264/131; 264/132; 427/180; 219/221

(57) ABSTRACT

A method for making a heat embossed design includes providing a substrate, spreading a layer of embossing powder on the substrate, and directing a heated tip of a tool into the layer of embossing powder to cause a selected portion of the powder to melt and adhere to the substrate. The remaining unmelted embossing powder is then removed from the substrate, thereby leaving the heat embossed design. Material adapted for securing embossing powder to the substrate (such as ink) is not added to the substrate prior to spreading the layer of embossing powder on the substrate. Further provided is a heat embossing kit that includes a tool having a heated tip configured to melt embossing powder spread on a substrate without material on the substrate for securing the powder to the substrate. A method for instructing a person to perform a heat embossing process is also provided.

### FIELD OF THE INVENTION

The present invention is directed to a method and apparatus for producing embossed designs on a surface, and more particularly for producing a heat embossed design on a surface using embossing powder.

### BACKGROUND OF THE INVENTION

In recent years, the scrapbooking industry has experienced explosive growth as scrapbookers old and alike have come to enjoy creating various artistic works that can be shared with others. In one aspect, a popular activity for scrapbookers is to create embossed designs on surfaces such as cardstock, paper, etc. One particular process for creating an embossed design uses embossing powder formed of a thermographic resin that, when heated, melts, hardens, and adheres to the surface on which it was placed. Typical is a wet embossing process in which a person uses a rubber stamp or an embossing ink pen to leave a layer of wet material, such as a pigment ink, on a surface after which embossing powder is sprinkled onto the stamped or drawn image. The embossing powder contacting the ink will adhere to the surface. The excess remaining powder is then shaken off of the wet design. The embossing powder remaining on the surface is heated, typically using a heat gun that blows a concentrated stream of hot air, to melt and seal the powder to the surface. After the melted powder has cooled and hardened, a slightly raised design is left on the surface.

Heretofore, known methods for creating an embossed design using embossing powder requires the use of pigment ink or other wet material on a surface prior to sprinkling embossing powder on the surface. Excess powder that does not adhere to the ink is removed prior to heating and melting the embossing powder.

While the foregoing method of embossing is presently found suitable by many scrapbookers, there remains room for improvements in methods and apparatus for making a heat embossed design on a surface. The present invention is directed to such an improvement.

### SUMMARY OF THE INVENTION

Embodiments of the present invention provide an improved method and apparatus for making a heat embossed design on a substrate, such as paper, cardstock, wood, leather, transparencies, foil, foam, fabrics, ribbon, cardboard, etc. In accordance with one embodiment of the invention, a method for making a heat embossed design includes providing a substrate, spreading a layer of embossing powder on the substrate, and directing a heated tip of a tool into the layer of embossing powder to cause a selected portion of the powder to melt and adhere to the substrate. Depending on the drawing motions of the person operating the tool, the portions of the embossing powder that contact the hot tip of the tool, melt and adhere to the substrate to form a heat embossed design. The remaining unmelted embossing powder is afterwards removed from the substrate, thereby leaving the heat embossed design. An important aspect of the method is that material adapted for securing the embossing powder to the substrate is not added to the substrate prior to spreading the layer of embossing powder on the substrate. Accordingly, pigment ink, stamp pads, embossing pens, etc., are not necessary, nor are they used on the substrate to adhere embossing powder to the substrate prior to melting the embossing powder. The method described above allows a person to create a freeform embossed design, as desired, in the layer of embossing powder on the substrate.

In further embodiments, the layer of embossing powder may be heated to create an embossed surface of melted powder on the substrate, after which the heated tip of the tool is directed into the embossed surface for creating a design in the embossed surface. Additional embossing powder may be added to the embossed surface prior to directing the heated tool into the embossed surface.

Further provided, in accordance with the present invention, is a heat embossing kit that includes a tool having an end configured to heat to a hot temperature. The kit further includes a tip configured to secure to the end of the tool and conduct heat from the tool. The tool, with the tip secured thereto, is adapted to heat to a temperature that melts embossing powder and produces an embossed design on a substrate when a layer of embossing powder is spread on the substrate without material on the substrate for securing the powder to the substrate. When the heated tip is directed into the layer of embossing powder, the tool creates a heat embossed design on the substrate.

The tip in the heat embossing kit may be a chisel tip having a slanted edge that comes to a sharp point. In one embodiment, the chisel tip may be permanently secured to the tool and further include a mechanism for attaching different tips to the tool over the chisel tip. One suitable mechanism for that purpose is outer threads on the chisel tip that engage inner threads defined in the different tip, thus allowing a person to screw on the different tip. Additional kinds of tips include, without limitation, a double edge tip, a pen tip, a slanted tip, a comb tip, a symbol tip, and a connector tip. These different types of tips, as shown and described herein, enable a person to create a wide variety of heat embossed designs on a substrate. The kit may further include instructions for making a heat embossed design on the substrate, as described herein.

According to yet a further embodiment of the invention, a method is provided for instructing a person to perform a heat embossing process. The method of instruction includes directing a person to spread a layer of embossing powder on a substrate, providing a tool with a tip adapted to conduct heat generated by the tool, and directing the person to place the heated tip into the layer of embossing powder to melt a selected portion of the powder and produce a heat embossed design on the substrate. As with other embodiments of the invention described herein, an important aspect of this embodiment is that the person is not directed to add any material to the substrate that is adapted to secure the embossing powder to the substrate prior to spreading the layer of embossing powder. Accordingly, extra materials, such as pigment inks, stamp pads, and embossing pens, are not needed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of a substrate having a layer of embossing powder spread thereon, and a tool having an end adapted for heating to a hot temperature with a tip secured thereto that conducts heat from the tool;

FIG. 2 is a pictorial diagram of the substrate and tool shown in FIG. 1, wherein a heated tip on the tool is shown being drawn through the embossing powder on the substrate, thereby creating an embossed design on the substrate;

FIG. 3 is a pictorial diagram of seven different types of tips configured to secure to an end of a tool as shown in FIGS. 1 and 2; and

FIG. 4 is a pictorial diagram of a substrate with an embossed surface of melted embossing powder, and a heated tool with a comb tip, as shown in FIG. 3, drawing a design in the embossed surface of the substrate.

### DETAILED DESCRIPTION OF THE PREFERRED EMBODIMENT

The following description provides details showing several preferred embodiments of the present invention. These embodiments are provided to illustrate examples of how the invention may be made and used for creating heat embossed designs on a substrate. The scope of the present invention is not restricted to the precise forms and features shown herein, but rather should be determined from the claims that follow and equivalents thereto.

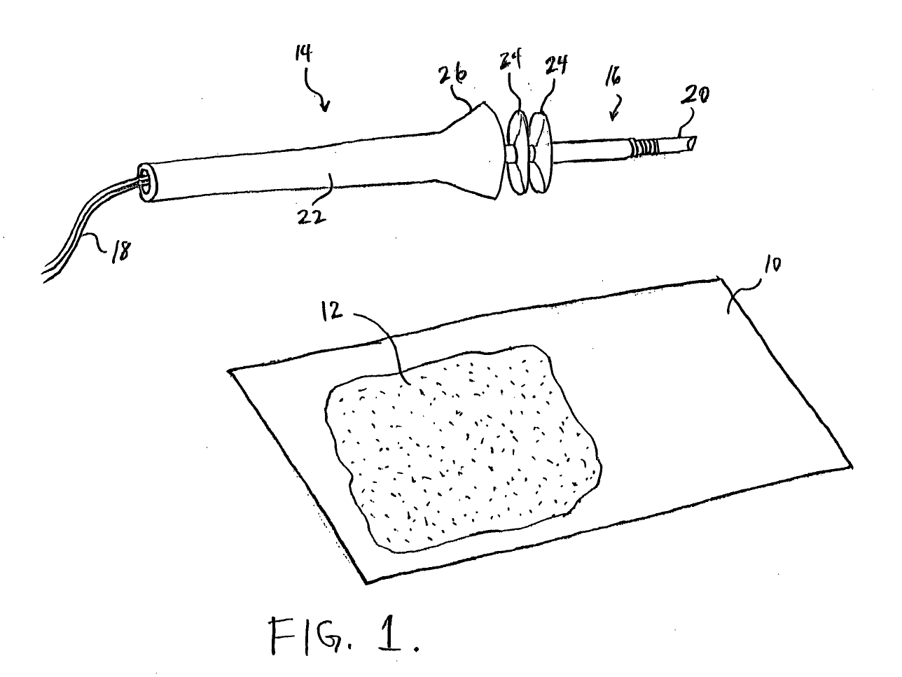

FIG. 1 illustrates a substrate 10 having a layer of embossing powder 12 spread thereon. Also shown in FIG. 1 is a tool 14 having an end 16 configured to heat to a hot temperature. The tool 14 may use any form of energy to heat the end 16, including electric energy. In electric embodiments of the tool 14, an electrical cord 18 may be used to conduct electricity to the tool 14.

To limit the amount of heat transferring from the end 16 of the tool to the handle 22 of the tool 14, one or more heat dispersing features may be attached to the end 16. In FIG. 1, heat conducting disks 24 are attached to the end 16 next to the handle 22 for dispersing heat into the air. A further guard is provided by forming a flared end 26 on the end of the handle towards the heated tip 16.

The tool 14 may be further configured to receive a tip 20 that secures to the end 16 of the tool. The tip 20 is preferably made of a material that is highly conductive of the heat produced at the end 16 of the tool. As will be described herein, the tip 20 may assume various forms and configurations to create a multitude of different heat embossed designs on a substrate, such as the substrate 10 shown in FIG. 1.

To make a heat embossed design on a substrate in accordance with one embodiment of the invention, a person first provides a substrate, such as the substrate 10 shown in FIG. 1. Any type of substrate to which melted embossing powder adheres may be used in the invention. These substrates include, without limitation, paper, cardstock, wood, leather, transparencies, foil, foam, fabrics, ribbon, cardboard, etc.

The person then spreads a layer of embossing powder on the substrate. Various forms of embossing powder are known in the scrapbooking art, and typically come in various granularities and colors. Embossing powder is generally a thermographic resin that is configured to melt in the presence of sufficient heat and adhere to a substrate on which the melted powder sits. When the melted powder cools, a hardened raised design is produced on the substrate. In accordance with the present invention, the embossing powder is spread directly on the substrate. Material adapted to secure the embossing powder to the substrate, such as a pigment ink, is not added to the substrate prior to spreading the layer of embossing powder on the substrate.

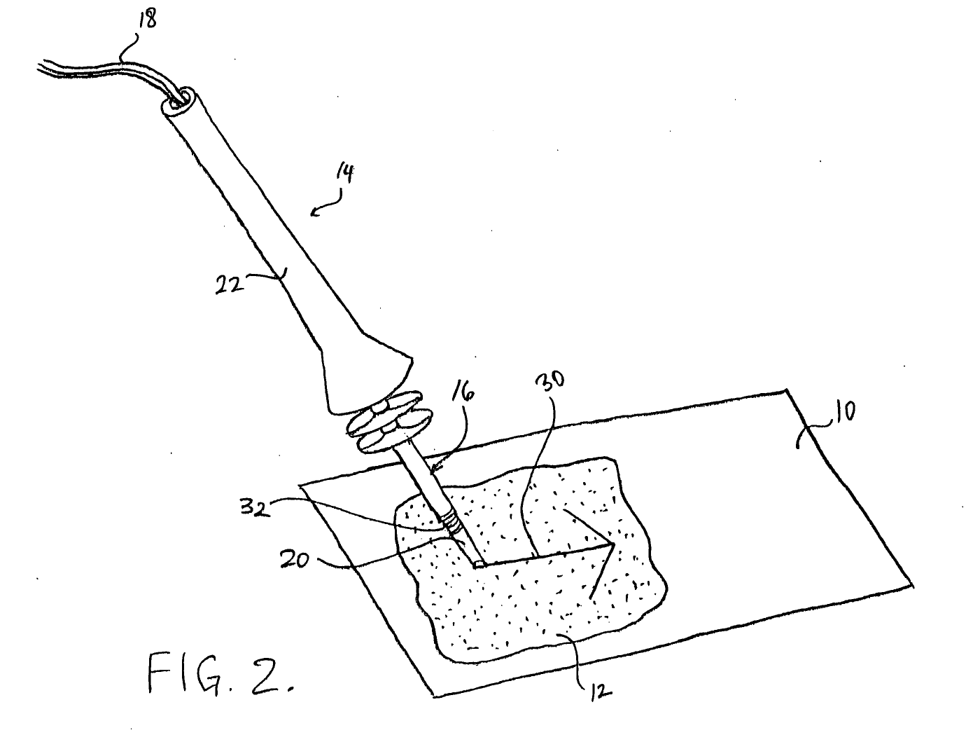

Once a layer of embossing powder 12 is spread on the substrate 10, as shown in FIG. 1, and the tip 20 attached to the end 16 of the tool 14 is heated, the heated tip of the tool 14 is directed into the layer of embossing powder 12, as shown in FIG. 2. The heated tip of the tool causes a selected portion of the powder 12 to melt and adhere to the substrate 10. The embossing powder 12 that does not come into contact with the heated tip 20 of the tool 14 does not melt and therefore does not adhere to the substrate 10, allowing it to be removed from the substrate once the embossed design is finished.

One advantage of the present invention is that the person using the tool 14 can draw a freeform design in the embossing powder 12 by drawing the heated tip through any portion of the powder 12. In FIG. 2, the heated tip 20 is shown having been drawn through the embossing powder 12, forming a design in the shape of an arrow 30. Once the heat-embossed design 30 is made on the substrate 10, the person withdraws the tool 14 from the embossing powder. The remaining unmelted embossing powder on the substrate can be removed by tipping the substrate 10 and shaking the powder off, preferably back into the container from which the embossing powder was obtained. The unmelted embossing powder in the container can then be used again. After the unmelted embossing powder is removed, the heat-embossed design 30 remains on the substrate 10.

Further provided in accordance with the present invention is a heat embossing kit that includes a tool having an end configured to heat to a hot temperature, such as the tool 14 described above. One preferred embodiment of the tool 14 is a type of tool as shown in FIGS. 1 and 2 that consumes approximately 30 watts. Where the tool 14 is adapted to operate in the United States, the tool 14 preferably operates using 120 volts. In foreign countries, the tool 14 may use other voltage electricity, as needed. Different tools using more or less than 30 watts, or even other forms of energy, may also be suitable for use in the invention.

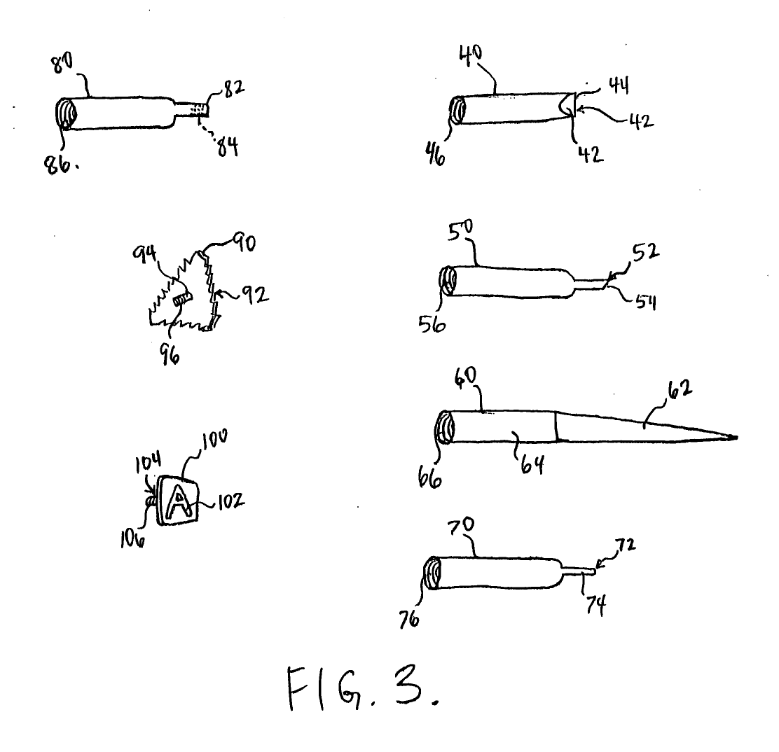

The heat embossing kit further includes a tip, such as the tip 20, configured to secure to the end of the tool and conduct heat from the tool. Many different design effects can be achieved, depending on the configuration of the tip used with the tool. In FIGS. 1 and 2, a chisel tip 20 is shown attached to the end 16 of the tool 14. The chisel tip has a slanted edge that comes to a sharp point. In one preferred embodiment, the chisel tip 20 is permanently secured to the tool 14 and further includes a mechanism for attaching a different tip to the tool over the chisel tip. The embodiment shown in FIGS. 1 and 2 includes outer threads 32 designed to engage inner threads defined on a different tip, such as one of the tips shown in FIG. 3, when the different tip is screwed onto the tool.

FIG. 3 depicts various examples of tips that may be included in the heat embossing kit and attached to the tool 14 via the outer threads 32 on the tool. For example, one type of tip is a double edge tip 40 having two slanted edges 42 that come together to create a single edge 44. In FIG. 3, one slanted edge 42 is shown, while the opposite slanted edge 42 is on the back side of the tip 40. Inner threads 46 of the tip 40 are adapted to engage with the outer threads 32 of the tip 20 shown in FIG. 2.

Another example of a tip is a slanted tip 50 that comes to a point 52. The point 52 has a slanted edge 54. Inner threads 56 are adapted to engage with the outer threads 32 of the tip 20 shown in FIG. 2.

Another example of a tip is a knife tip 60 that looks like a knife, but is not sharp. The knife tip 60 includes a flat portion 62 that extends outwardly from a base portion 64 of the tip 60. The length of the flat portion 62 may be longer than the base portion 64 of the tip. Inner threads 66 of the tip 60 are adapted to engage the outer threads 32 shown in FIG. 2.

Yet another example of a tip is a pen tip 70 having a point 72 that is rounded off and smooth. In one preferred embodiment, the point 72 has a diameter 74 that is substantially less than the diameter of the tip 70. A thin diameter 74 enables the tip 72 to produce fine designs in embossing powder on the substrate. Inner threads 76 of the pen tip 70 are adapted to engage the outer threads 32 shown in FIG. 2.

Still another example of a tip is a connector tip 80. The connector tip 80 is typically not used alone with the tool 14, but includes a further connecting mechanism for attaching additional tips to the connector tip. In the embodiment shown in FIG. 3, the connector tip 80 includes an end 82 having a hollow interior. Internal threads 84 inside the end 82 are adapted to engage outer threads on another tip, such as the comb tip 90 and symbol tip 100 shown in FIG. 3 and described in further detail below. Inner threads 86 of the connector tip 80 are adapted to engage the outer threads 32 shown in FIG. 2.

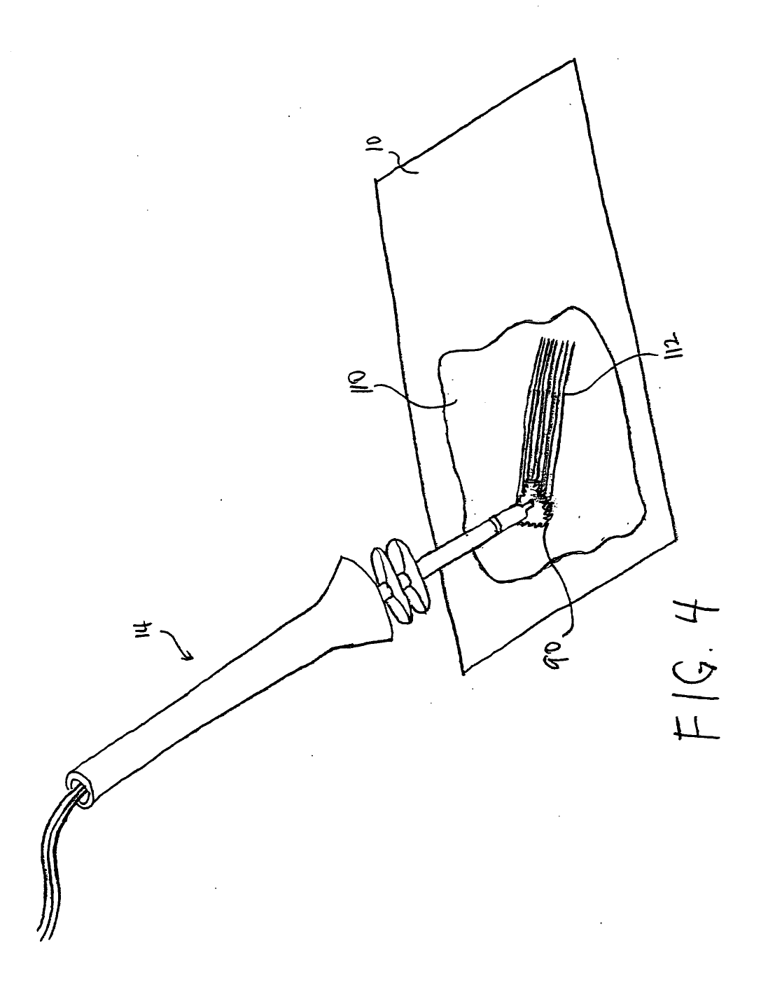

A comb tip 90, as shown in FIG. 3, may include multiple peripheral edges, some or all of which having grooves 92 defined therein. As shown and described below with respect to FIG. 4, the grooves 92 of the comb tip 90 may be used to make multiple lines of a design at the same time. The comb tip 90 includes a post 94 with outer threads 96 defined thereon. The outer threads 96 are adapted to engage the internal threads 84 of the connector tip 80.

Further illustrated in FIG. 3 is a symbol tip 100 that may be used to make an embossed design in the form of a symbol 102 defined on the tip 100. The tip 100, as shown, includes a flat surface on which the symbol 102 (such as a number, letter, etc.) is formed though other embodiments of a symbol tip 100 may take other shapes and forms. A post 104 defined on the back of the symbol tip 100 includes outer threads 106 that are adapted to engage the internal threads 84 of the connector tip 80.

In further embodiments of the invention, a heat embossed design may be formed on a substrate by first heating a layer of embossing powder on the substrate to create an embossed surface 110, as shown in FIG. 4. The embossed surface 110 is comprised of a layer of embossing powder heated by a heat gun, or other heat producing device, until the layer of embossing powder is melted. Additional embossing powder may be added to the embossed surface 110 and melted to create a desired depth for the embossed surface 110.

A hot texturing technique may then be applied to the embossed surface 110 by spreading additional embossing powder, if desired, over the area of the surface 110 where a texture is desired. Then, using one of the tips shown in FIG. 3, such as the comb tip 90, the tool is drawn through the embossed surface 110 to create a design in the embossed surface. As shown in FIG. 4, the comb tip 90 may produce multiple parallel lines 112. Alternatively, the comb tip 90 may be used to create wavy lines, swirls, etc., depending on the manner in which the tool 14 is drawn across the embossed surface 110.

In a hot etching technique, embossing powder is added to an area of the embossed surface 110, if desired, and a tip such as the pen tip 70, the slanted tip 50, or the chisel tip 20, may be used to create a pattern of cross-hatches, swirls, stripes, etc., over the embossed surface 10. Wherever the hot tip touches, an etched result will appear in the embossed surface 110. As may be appreciated, different tips can create different effects in the embossed surface 110.

In yet another embodiment, a method according to the invention may be used to create embossed droplets on a substrate. In that regard, a tool such as the tool 14 having a tip 20, as shown in FIG. 1, is heated and dipped directly into a container of embossing powder. The heated tip is removed quickly from the powder and placed over the desired area of the substrate where the embossed droplet is desired. The melted powder on the tip 20 drips onto the substrate, thereby adhering to the substrate and forming a raised droplet design on the substrate.

To clean any of the tips described herein, the tool 14 may be cooled, after which a fine grain sandpaper can be used to gently scrape away residue of melted embossing powder on the end 16 or the tip 20 of the tool.

A blended embossed surface may also be made on a substrate in accordance with the present invention. Different colors of embossing powder may be spread on the substrate such that the different colored powders partially or completely overlap. For best results, 2-3 layers of each color are spread on the substrate. Starting in the middle between the two colors, the heated tip 20 of the tool 14 is worked in a back and forth motion using the heated tip 20 to blend the colors together. The sweeping motion of the heated tip 20 preferably extends across the entire surface of the embossing powders on the substrate. At the end of the process, a heat gun may be used to generally heat the surface to smooth out the surface, if desired.

The present invention also includes a method of instruction for performing a heat embossing process. In accordance with one embodiment of the method, a person is directed to spread a layer of embossing powder on a substrate and is provided with a tool having a tip adapted to conduct heat generated by the tool. The method further comprises directing the person to heat the tip of the tool and place the tip into the layer of embossing powder to melt a selected portion of the powder, thereby producing a heat embossed design on the substrate. As with other embodiments of the invention discussed herein, the person is not directed to add any material (such as ink) to the substrate to secure the embossing powder to the substrate prior to spreading the layer of embossing powder on the substrate.

While several preferred embodiments of the invention have been illustrated and described, it will be appreciated that various changes can be made therein without departing from the spirit and scope of the invention. The scope of the invention claimed in this application should be determined in reference to the claims that follow and equivalents thereto.

1. A method of making a heat embossed design on a substrate, comprising:
providing a substrate;
spreading a layer of embossing powder on the substrate;
directing a heated tip of a tool into the layer of embossing powder to cause a selected portion of the powder to melt and adhere to the substrate; and
removing the remaining unmelted embossing powder from the substrate, thereby leaving a heat embossed design on the substrate,
wherein material adapted for securing the embossing powder to the substrate is not added to the substrate prior to spreading the layer of embossing powder on the substrate.

2. The method of claim 1, further comprising heating the layer of embossing powder to create an embossed surface of melted powder on the substrate, after which the heated tip of the tool is directed into the embossed surface for creating a design in the embossed surface.

3. The method of claim 2, further comprising adding embossing powder to the embossed surface prior to directing the heated tip into the embossed surface, thereby melting a selected portion of the embossing powder and creating the design on the embossed surface.

4. A heating embossing kit, comprising:
a tool having an end configured to heat to a hot temperature;
a tip configured to secure to the end of the tool and conduct heat from the tool,
wherein the tool, with the tip secured thereto, is adapted to heat to a temperature that melts embossing powder and produces an embossed design on a substrate when a layer of embossing powder is spread on the substrate without material securing the powder to the substrate and the heated tip is directed into the layer of embossing powder on the substrate.

5. The heat embossing kit of claim 4, wherein the tip is a chisel tip having a slanted edge that comes to a sharp point.

6. The heat embossing kit of claim 5, wherein the chisel tip is permanently secured to the end of the tool and further includes a mechanism for attaching a different tip to the tool over the chisel tip.

7. The heat embossing kit of claim 6, wherein the mechanism is outer threads on the chisel tip adapted to engage inner threads on the different tip.

8. The heat embossing kit of claim 6, further comprising a connector tip adapted to attach to the chisel tip and further provide a mechanism for attaching the different tip to the connector tip.

9. The heat embossing kit of claim 4, wherein the tip is a double-edge tip having two slanted edges that come together a create a single edge.

10. The heat embossing kit of claim 4, wherein the tip is a pen tip having a point that is rounded off and smooth.

11. The heat embossing kit of claim 4, wherein the tip is a slanted tip that comes to a point, wherein the point has a slanted edge.

12. The heat embossing kit of claim 4, wherein the tip is a comb tip having grooves along a peripheral edge of the tip.

13. The heat embossing kit of claim 4, wherein the tip is configured with a flat surface having a symbol formed thereon.

14. The heat embossing kit of claim 4, wherein the kit further includes instructions for making a heat embossed design on a substrate by spreading of embossing powder on the substrate, directing a heated tip of the tool into the layer of embossing powder to cause a selected portion of the powder to melt and adhere to the substrate, and remove the remaining unmelted embossing powder from the substrate, without adding any material to the substrate to secure the embossing powder to the substrate prior to spreading the layer of embossing powder on the substrate.

15. A method of instruction for performing a heat embossing process, comprising:
directing a person to spread a layer of embossing powder on a substrate;
providing the person with a tool having a tip adapted to conduct heat generated by the tool; and
directing the person to heat the tip of the tool and place the tip into the layer of embossing powder to melt a selected portion of the powder and produce a heat embossed design on the substrate,
wherein the person is not directed to add any material to the substrate to secure the embossing powder to the substrate prior to spreading the layer of embossing powder on the substrate.
